(19) United States
(12) Patent Application Publication
(10) Pub. No.: US 2015/0201469 A1
(43) Pub. Date: Jul. 16, 2015

(54) HEATING APPARATUS

(71) Applicant: Tokyo Electron Limited, Tokyo (JP)

(72) Inventor: Kouji SHIMOMURA, Yamanashi (JP)

(21) Appl. No.: 14/598,063

(22) Filed: Jan. 15, 2015

(30) Foreign Application Priority Data
Jan. 16, 2014 (JP) 2014-005987

(51) Int. Cl. H05B 6/64; G01K 11/20

(52) U.S. Cl. CPC H05B 6/645; H05B 6/6411; G01K 11/20

(57) ABSTRACT

A heating apparatus includes a heat source; a holder having a contact portion configured to support an object to be processed; a rotation driving unit configured to rotate the holder; a luminous body including a fluorescent material or a phosphorescent material provided in the contact portion; and a fluorescent thermometer configured to measure a temperature of the object based on light from the luminous body. The fluorescent thermometer includes: a light source which is separated from the holder and configured to generate excitation light for exciting the luminous body; light receivers separated from the holder, each of the light receivers having a photodetector configured to receive the light from the luminous body; and a processing unit configured to calculate the temperature based on intensity of the light received by the photodetector of each of the light receivers.

### CROSS-REFERENCE TO RELATED APPLICATIONs

This application claims priority to Japanese Patent Application No. 2014-005987 filed on Jan. 16, 2014, the entire contents of which are incorporated herein by reference.

### FIELD OF THE INVENTION

The present invention relates to a heating apparatus.

### BACKGROUND OF THE INVENTION

When electronic devices are manufactured, an object to be processed such as a semiconductor substrate or the like may be heated. In general, a heating apparatus using a lamp heater is used for the heating. In such a heating apparatus, a thermometer such as a thermocouple or the like is generally used to measure a temperature of the object to be processed during the processing.

Meanwhile, recently, a microwave heating apparatus for heating the object to be processed by using a microwave is suggested. The microwave heating apparatus is disclosed in, e.g., Japanese Patent Application Publication No. 2013-152919. As disclosed in Japanese Patent Application Publication No. 2013-152919, the microwave heating apparatus employs a radiation thermometer such as a pyrometer. This is because a thermocouple cannot be used in the microwave heating apparatus due to the effect from the microwave.

However, among various radiation thermometers, a pyrometer capable of measuring a high temperature with high accuracy cannot measure a relatively low temperature, e.g., 300° C. or below.

### SUMMARY OF THE INVENTION

In view of the above, the present invention provides a heating apparatus including a thermometer capable of measuring a temperature of 300° C. or below with high accuracy.

In accordance with the present invention, there is provided a heating apparatus comprising: a heat source configured to heat an object to be processed; a holder having a contact portion configured to support the object to be processed while being in contact with a surface of the object to be processed; a rotation driving unit configured to rotate the holder; a luminous body including a fluorescent material or a phosphorescent material provided in the contact portion; and a fluorescent thermometer configured to measure a temperature of the object based on light from the luminous body, the fluorescent thermometer including: a light source which is separated from the holder and configured to generate excitation light for exciting the luminous body; one or more light receivers separated from the holder, each of the one or more light receivers having a photodetector configured to receive the light from the luminous body; and a processing unit configured to calculate the temperature based on intensity of the light received by the photodetector of each of the one or more light receivers.

As described above, there is provided the heating apparatus including the thermometer capable of measuring a temperature of 300° C. or below with high accuracy.

### BRIEF DESCRIPTION OF THE DRAWINGS

The objects and features of the present invention will become apparent from the following description of embodiments, given in conjunction with the accompanying drawings, in which:

FIG. 1 schematically shows a heating apparatus in accordance with an embodiment of the present invention;

FIG. 2 illustrates a configuration of a high voltage power supply unit PS;

FIG. 3 is a top view showing a fluorescence thermometer and a holder in accordance with an embodiment of the present invention;

FIG. 4 is an enlarged cross sectional view showing a part of the holder in accordance with the embodiment of the present invention;

FIGS. 5A and 5B are enlarged cross sectional views showing a contact portion of the holder;

FIG. 6 shows the fluorescence thermometer and the contact portion arranged along an extension direction of a rotation track of the contact portion of the holder;

FIG. 7 shows relation between time and a luminous intensity of light received by a light receiver;

FIG. 8 is a top view showing a holder in accordance with another embodiment of the present invention;

FIG. 9 is an enlarged cross sectional view showing a part of a holder in accordance with still another embodiment of the present invention;

FIG. 10 is a top view showing a holder in accordance with further still another embodiment of the present invention;

FIG. 11 shows a radiation thermometer and a fluorescence thermometer in accordance with another embodiment of the present invention; and

FIG. 12 shows a radiation thermometer and a fluorescence thermometer in accordance with still another embodiment of the present invention.

### DETAILED DESCRIPTION OF THE EMBODIMENTS

Hereinafter, embodiments of the present invention will be described in detail with reference to the accompanying drawings. In the respective drawings, like reference numerals will be used for like or corresponding parts.

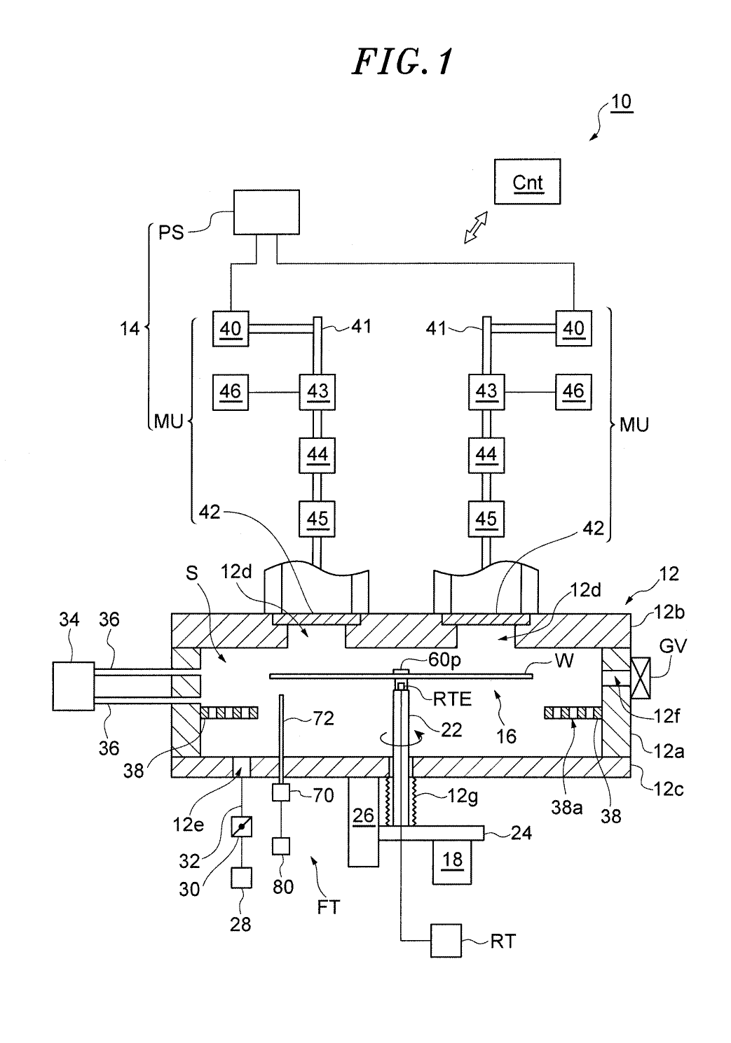

FIG. 1 schematically shows a heating apparatus in accordance with an embodiment of the present invention. Fig. illustrates a partial cross sectional structure of a processing chamber of the heating apparatus. A heating apparatus 10 shown in FIG. 1 heats an object to be processed (hereinafter, referred to as “wafer”) W.

The heating apparatus 10 includes a processing chamber 12, a heat source 14, a holder 16, a rotation driving unit 18, and a fluorescence thermometer FT. The processing chamber 12 defines a processing space S. In the processing space S, the wafer W is heated. The processing chamber 12 is made of, e.g., metal. For example, the processing chamber 12 may be made of, e.g., aluminum, aluminum alloy, stainless steel or the like.

The heat source 14 heats the wafer W. To do so, the heat source 14 generates energy for heating the wafer W. In the present embodiment, the heat source 14 introduces a microwave into the processing chamber 12. However, the energy generated by the heat source 14 is not limited to the microwave. A specific example of the heat source 14 using the microwave will be described later.

In the present embodiment, the processing chamber 12 has a sidewall 12a, a ceiling portion 12b and a bottom portion 12c. The ceiling portion 12b defines the processing space S from the top. A plurality of microwave introduction ports 12d is formed at the ceiling portion 12b. The bottom portion 12c defines the processing space S from the bottom. A gas exhaust port 12e is formed at the bottom portion 12c. The sidewall 12a disposed between the ceiling portion 12b and the bottom portion 12c defines the processing space S from the side. A port 12f is formed at the sidewall 12a to allow the wafer W to be loaded and unloaded therethrough. The port 12f can be opened or closed by a gate valve GV.

In one example, the sidewall 12a has a square column shape. In this example, the processing space S is a cubical space. The inner surface of the sidewall 12a serves as a microwave reflective surface. For example, the inner surface of the sidewall 12a and the inner surfaces of the ceiling portion 12b and the bottom portion 12c are mirror-finished, so that the reflection efficiency of radiant heat from the wafer W can be improved. Therefore, the surface area of the inner surface of the processing chamber 12 can be reduced. Accordingly, the absorption of the microwave by the wall of the processing chamber 12 can be reduced and the reflection efficiency of the microwave can be improved. As a result, the heating efficiency of the wafer W is increased.

A holder 16 is provided in the processing chamber 12. The holder 16 is configured to support the wafer W. The holder 16 is supported by a shaft 22. The shaft 22 penetrates through the bottom portion 12c and extends in a vertical direction. An upper end portion of the shaft 22 is connected to a substantially central portion of the holder 16. A lower end portion of the shaft 22 is connected to a movable connection unit 24. The movable connection unit 24 connects an elevation driving unit 26 and the rotation driving unit 18. The elevation driving unit 26 is configured to vertically move the shaft 22. The rotation driving unit 18 is configured to rotate the shaft 22 about a central axis (i.e., axis of rotation) of the shaft 22. When the rotation driving unit 18 rotates the shaft 22, the holder 16 rotates about its center. Meanwhile, a sealing device 12g such as a bellows or the like may be provided at the bottom portion 12c of the processing chamber 12 to seal a hole through which the shaft 22 penetrates.

A gas exhaust unit 28 is connected to the gas exhaust port 12e formed at the bottom portion 12c. The gas exhaust unit 28 includes a vacuum pump such as a dry pump or the like. In the present embodiment, the gas exhaust unit 28 is connected to the gas exhaust port 12e via a pressure control valve 30 and a gas exhaust line 32. Meanwhile, the heating apparatus 10 may heat the wafer W under an atmospheric pressure environment. In that case, gas exhaust equipments provided at a facility where the heating apparatus 10 is installed may be used, instead of the vacuum pump, as the gas exhaust unit 28.

The heating apparatus 10 may further include a gas supply unit 34. The gas supply unit 34 includes a gas source, a flow rate controller and a valve. The gas supply unit 34 is connected to the inside of the processing chamber 12 through one or more lines 36. The gas supply unit 34 can supply a gas from the gas source at a controlled flow rate into the processing chamber 12. The gas supply unit 34 can supply, e.g., N₂, Ar, He, Ne, O₂, H₂ or the like, as a processing gas or a cooling gas.

The heating apparatus 10 may further include a rectifying plate 38. The rectifying plate 38 is provided between the holder 16 and the sidewall 12a. A plurality of through holes 38a extending in a vertical direction is formed at the rectifying plate 38. The rectifying plate 38 may be made of metal, e.g., aluminum, aluminum alloy, stainless steel or the like.

In the present embodiment, the heating apparatus 10 may further include one or more radiation thermometers RT. The radiation thermometer RT has a light receiving end RTE provided near the wafer W and a photodetector. A signal corresponding to the intensity of the light received by the light receiving end RTE is output from the photodetector. Further, the radiation thermometer RT has a temperature calculation unit for calculating a temperature of the wafer W based on the signal from the photodetector. The radiation thermometer RT may be used for measuring a temperature of the wafer W ranging from, e.g., 300° C. to 1000° C.

In the present embodiment, the heating apparatus 10 may further include a control unit Cnt. The control unit Cnt may be configured as, e.g., a computer. The control unit Cnt controls the respective units of the heating apparatus 10. Specifically, the control unit Cnt transmits control signals to the respective units of the heating apparatus 10 to control a microwave output of the heat source 14 to be described later, a gas flow rate, a pressure in the processing chamber 12, a rotation speed of the holder 16, a gas exhaust amount of the gas exhaust unit 28, and the like.

Hereinafter, an example of the heat source 14 using a microwave will be described in detail. The heat source 14 introduces the microwave into the processing chamber 12. The heat source 14 has one or more microwave units MU and a high voltage power supply unit PS. In the example shown in FIG. 1, the heat source 14 has a plurality of microwave units MU.

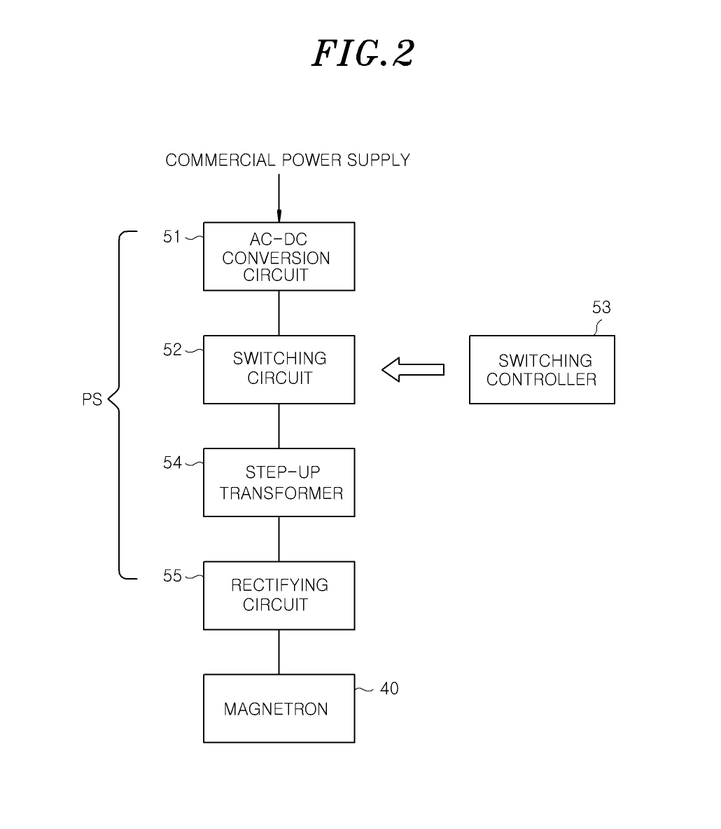

Each of the microwave units MU includes a magnetron 40, a waveguide 41 and a transmission window 42. The magnetron 40 is connected to the high voltage power supply unit PS. FIG. 2 shows a configuration example of the high voltage power supply unit PS. As shown in FIG. 2, the high voltage power supply unit PS includes an AC-DC conversion circuit 51, a switching circuit 52, a switching controller 53, a step-up transformer 54, and a rectifying circuit 55.

The AC-DC conversion circuit 51 rectifies an AC (e.g., three phase 200V) supplied from the commercial power supply and converts it to a DC having a predetermined waveform. The AC-DC conversion circuit 51 is connected to the switching circuit 52. The switching circuit 52 controls on/off of the DC converted by the AC-DC conversion circuit 51. In the switching circuit 52, the switching controller 53 performs phase-shift PWM (pulse width modulation) control or PAM (pulse amplitude modulation) control, thereby generating pulsed voltage waveform. The step-up transformer 54 boosts the voltage output from the switching circuit 52 to a predetermined level. The rectifying circuit 55 rectifies the voltage boosted by the step-up transformer 54 and supplies plies the rectified voltage to the magnetron 41.

The magnetron 40 generates a microwave based on a high. voltage applied from the high voltage power supply PS. The microwave thus generated has a frequency of, e.g., 2.45 GHz, 5.8 GHz, or the like. The magnetron 40 is connected to the waveguide 41.

The microwave generated by the magnetron 40 is transmitted into the processing chamber 12 through the waveguide 41. The transmission window 42 is fixed to the ceiling portion 12b to block the microwave introduction ports 12d. The transmission window 42 is made of a dielectric material, e.g., quartz. The microwave transmitted through the waveguide 41 is introduced into the processing chamber 12 through the transmission window 42.

The microwave unit MU includes a circulator 43, a detector 44, a tuner 45 and a dummy load 46. The circulator guides the microwave from the magnetron 40 to the processing chamber 12 and guides a reflection wave from the processing chamber 12 to the dummy load 46. The dummy load 46 converts the reflection wave guided from the circulator 43 into heat.

The detector 44 detects the reflection wave in the waveguide 41. The detector 44 may include, e.g., an impedance monitor, specifically, a standing wave monitor for detecting an electric field of a standing wave in the waveguide 41. The reflection wave can be detected based on the detection result of the standing wave monitor. Meanwhile, the detector 44 may include a directional coupler capable of detecting a traveling wave and a reflection wave.

The tuner 45 performs impedance matching between the magnetron 40 and the processing chamber 12. The tuner 45 performs the impedance matching based on the detection result of the detector 44. For example, the tuner 45 can control the impedance by controlling a protruding amount of a conductive plate into the inner space of the waveguide 41.

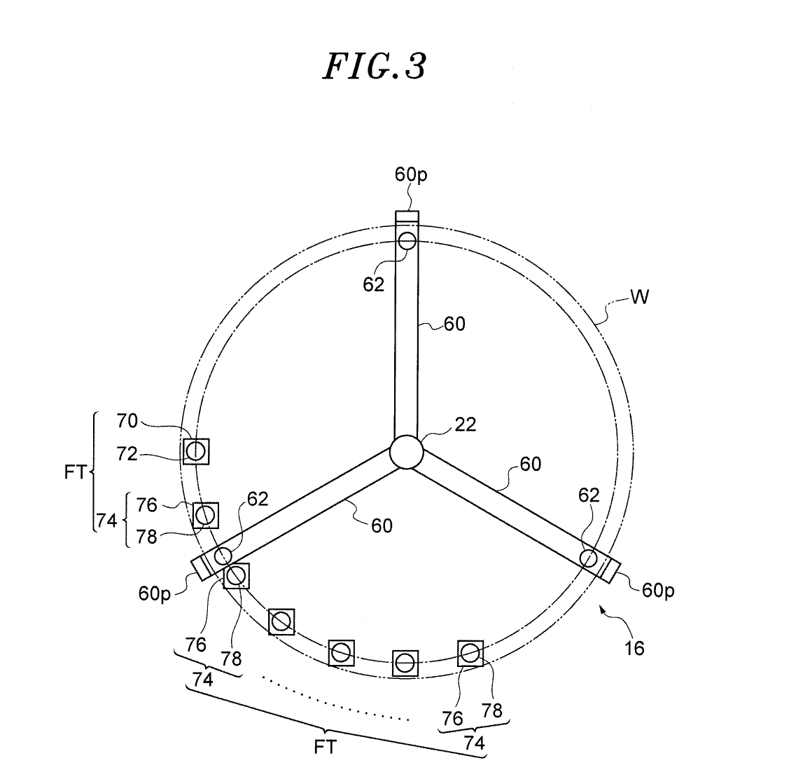

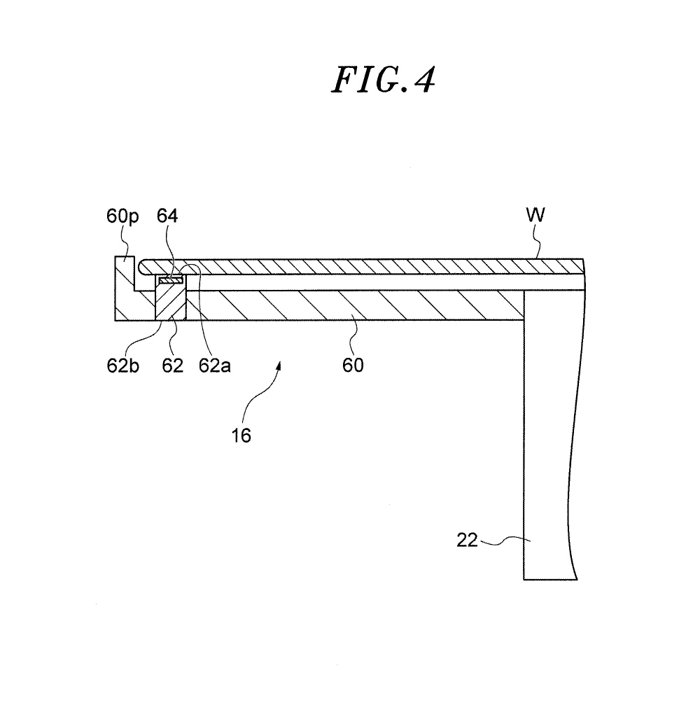

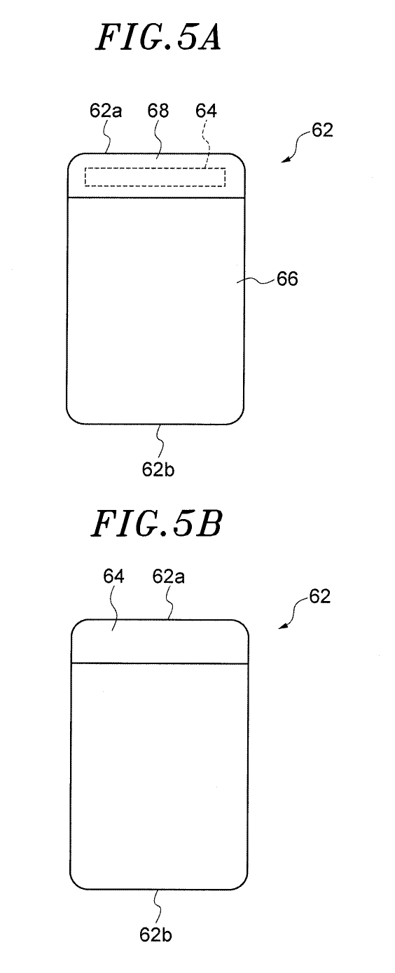

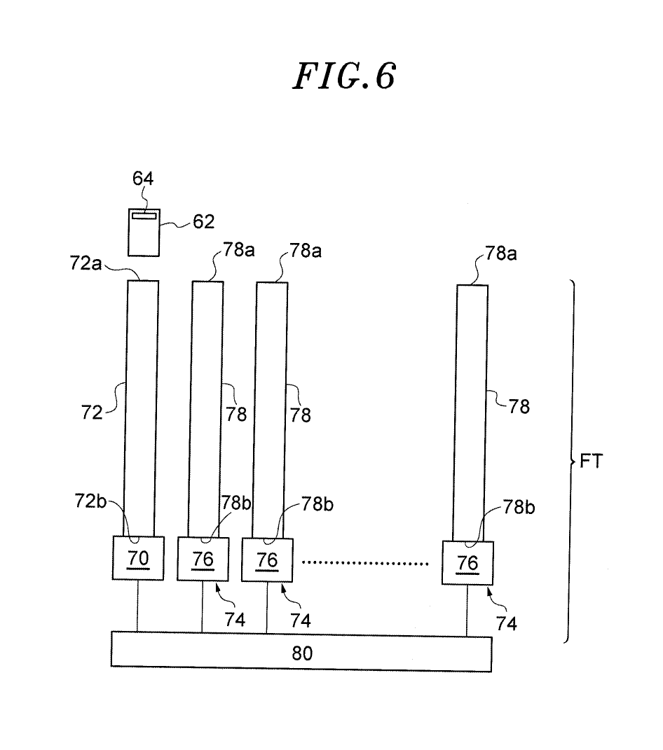

Hereinafter, the holder 16 and the fluorescent thermometer FT will be described in detail with reference to FIGS. 3 to 6. FIG. 3 is a top view of the holder and the fluorescent thermometer in accordance with the embodiment of the present invention. FIG. 4 is a cross sectional view showing a part of the holder in accordance with the embodiment of the present invention. FIGS. 5A and 5B illustrate a contact portion of the holder. FIG. 6 shows the contact portion and the fluorescent thermometer arranged along an extension direction of a rotation track of the contact portion of the holder.

As shown in FIGS. 3 and 4, the holder 16 of the present embodiment has a plurality of arms 60. One ends of the arms 60 are fixed to the shaft 22. The arms 60 extend in a radial direction with respect to the axis of rotation (i.e., central axis) of the shaft 22. Protrusions 60p are formed at the other ends of the arms 60. Each of the protrusions 60p protrudes upward compared to the other portion the corresponding arm 60. A distance between each of the protrusions 60p and the axis of rotation of the shaft 22 is set to be slightly longer than a radius of the wafer W. Accordingly, the protrusions 60p of the arms 60 prevent the wafer W from being separated from the holder 16 during the rotation of the holder 16.

A contact portion 62 is provided between the one end and the other end of each of the arms 60. In the present embodiment, the contact portions 62 are arranged in a circular shape about the axis of rotation of the shaft 22. Each of the contact portions 62 extends in a vertical direction and has a first end 62a and a second end 62b. The first end 62a corresponds to an upper end of the contact portion 62 and supports the wafer W while being in contact with the backside of the wafer W. The second end 62b corresponds to a lower end of the contact portion 62. Meanwhile, in the example shown in FIG. 3, the wafer W is supported by three contact portions 62. In other words, in the heating apparatus 10 shown in FIG. 3, the wafer W is supported at three points. However, in the heating apparatus 10, the wafer W may be supported at more than three points. In other words, the wafer W may be supported by contact portions provided at four or more arms.

A luminous body 64 is provided in the contact portion 62. A part of the contact portion 62 between the luminous body 64 and the second end 62b is made of a material transparent to the light generated by the luminous body 64. For example, the contact portion 62 may be made of the same quartz as an optical fiber.

As shown in FIG. 5A, in the illustrated contact portion 62, a sealant 68 may be provided at an upper end of an approximately columnar main portion 66 and the luminous body 64 may be embedded in the sealant 68. Further, as shown in FIG. 5B, in the illustrated contact portion 62, a fluorescent glass may be provided at a leading end of the main portion 66. In this case, the fluorescent glass serves as the luminous body 64. The fluorescent glass is fused to the leading end of the main portion 66 or coupled thereto by liquid glass adhesive.

The luminous body 64 receives excitation light to generate light such as fluorescent light or phosphorescent light and may include a light emitting material such as a fluorescent material, a phosphorescent material or the like. The light emitting material forming the luminous body 64 may be any material as long as relaxation time such as fluorescent lifetime can be measured. Specifically, the light emitting material can be selected based on a rotation speed of the wafer W, the number of light receivers, a distance between a light guiding part for guiding excitation light from the light source and a light guiding part of the light receiver, an arrangement pitch of the light receivers and the like. In other words, the number of the light receivers, the distance between the light guiding part for guiding the excitation light from the light source and the light guiding part of the light receiver, the arrangement pitch of the light receivers and the like can be set based on the light emitting material forming the luminous body 64 and the rotation speed of the wafer W.

For example, the light emitting material forming the luminous body 64 may be obtained by doping Zn₂SiO₄ with Mn. Further, the light emitting material may be obtained by adding YAG to the material in which Zn₂SiO₄ is doped with Mn. These light emitting materials may have a fluorescence lifetime of about 10 msec or less. For example, the light emitting material may also be ruby (Al₂O₃ doped with Cr), rare earth oxide or a mixture of rare earth and SiO₂. These light emitting materials have a fluorescence lifetime of about 1 msec at a room temperature. In addition, a SiAlon light phosphor may be used as the light emitting material.

As shown in FIGS. 3 and 6, the fluorescent thermometer FT includes a light source 70 and one or more light receivers 74. In the example shown in FIGS. 3 and 6, the fluorescent thermometer FT includes a plurality of light receivers 74. The number of the light receivers 74 may be determined based on the light emitting material of the luminous body 64, the rotation speed of the wafer W, and the like. For example, the wafer W rotates at a rotation speed of 20 rpm and at a maximum rotation speed of 50 to 60 rpm. The relaxation time of the luminous body 64 has an order of a few milliseconds as described above. Therefore, the light receivers 74 can receive the light while being spaced from each other at an interval of about 1 cm to 2 cm on the rotation path of the luminous body 64. Further, the light receivers 74 may be arranged on the corresponding path to receive the light within an angle of about 45° with respect to the central axis of the shaft 22. Meanwhile, if the relaxation time such as fluorescent lifetime can be measured by a single light receiver, there may be provided a single light receiver.

The light source 70 for generating excitation light is configured to irradiate light to the rotation track of the luminous body 64. The light source 70 is separated from the holder 16. In other words, the light source 70 is configured not to rotate together with the holder 16. The light source 70 includes, e.g., a light emitting device for generating UV light such as LED or a light emitting device such as a laser device. Further, the light source 70 may include a driving circuit for driving the light emitting device.

In the present embodiment, the light source 70 irradiates the excitation light to the luminous body 64 through a light guiding part 72. The light guiding part 72 is separated from the holder 16 so as not to rotate together with the holder 16. In this example, the light guiding part 72 is a light guiding member such as an optical fiber. The light guiding part 72 has one end 72a and the other end 72b. The other end 72b of the light guiding part 72 is optically coupled to the light source 70 and the one end 72a guides the excitation light from the light source 70 to the luminous body 64 when the luminous body 64 passes the space thereabove. Specifically, the one end 72a of the light guiding part 72 is disposed at a position on the rotation track of the luminous body 64. Therefore, the one end 72a of the light guiding part 72 is optically coupled to the luminous body 64 through the second end 62b of the contact portion 62 when the luminous body 64 passes the space thereabove. As a consequence, the luminous body 64 receives the excitation light from the light source 70 and generates light such as fluorescent light, or phosphorescent light.

The light receivers 74 receive the light from the luminous body 64 and output a signal corresponding to the intensity of the light. The light receivers 74 are separated from the holder 16 so as not to rotate together with the holder 16. Each of the light receivers 74 includes a photodetector 76. The photodetector 76 has a light receiving device, e.g., a photodiode or the like. Further, the photodetector 76 has a circuit for converting an output of the light receiving device to a digital signal corresponding to the intensity of the light received by the corresponding light receiving device.

The light receivers 74 are disposed to receive the light from the luminous body 64 at positions on the rotation track of the luminous body 64. In this example, each of the light receivers 74 has a light guiding part 78. The light guiding part 78 is a light guiding member such as an optical fiber. The light guiding parts 78 have one ends 78a and the other ends 78b. The one ends 78a of the light guiding part 78 of the light receivers 74 are arranged along the rotation track of the luminous body 64 and the other ends 78b of the light guiding part 78 are optically coupled to the photodetectors 76 corresponding thereto. Therefore, when the luminous body 64 passes the space above the one end 78a of the light guiding part 78, the light is received by the photodetector 76 through the light guiding part 78. Further, the signal corresponding to the intensity of the received light is output from the photodetector 76.

The fluorescent thermometer FT further includes a processing unit 80. The processing unit 80 is connected to the light source 70 and the photodetectors 76 of the light receivers 74. The processing unit 80 supplies to the light source 70 a signal for controlling emission of the light source 70 and timing of the emission. The emission timing of the light source 70 is controlled such that the excitation light is irradiated to the luminous body 64 at least when the contact portion 62 passes the one end 72a of the light guiding part 72. Further, the processing unit 80 receives the signals (digital signals or analog signals) output from the photodetectors 76 of the light receivers 74 and calculates a temperature based on the corresponding signals.

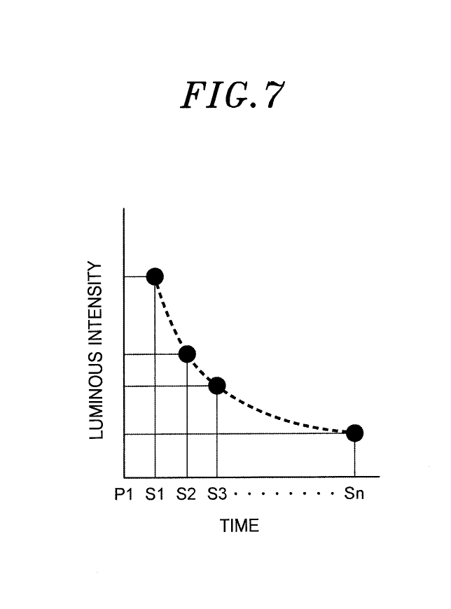

FIG. 7 illustrates relation between time and luminous intensity of light received by the light receiver.

In FIG. 7, at time P1, the excitation light is irradiated to the luminous body 64 and the luminous body 64 emits light. Then, at times S1, S2, S3, . . . , Sn, the photodetectors 76 of the light receivers 74 receive the light from the luminous body 64 in the arrangement order in the circumferential direction. As shown in FIG. 7, the intensity of the light from the luminous body 64 is gradually decreased as the lifetime of the luminous body 64 is decreased over time. Therefore, the processing unit 80 can obtain the relaxation time such as the fluorescent lifetime based on the signals from the photodetectors 76 of the light receivers 74. The relaxation time corresponds to the temperature of the luminous body 64, so that the processing unit 80 can calculate the temperature of the luminous body 64 based on the relaxation characteristics. Since the luminous body 64 is provided in the contact portion 62 that comes into contact with the wafer W, the temperature of the wafer W can be measured with high accuracy by measuring the temperature of the luminous body 64. Besides, since the heating apparatus 10 includes the fluorescent thermometer FT, the temperature of 300° C. or below can be measured with high accuracy.

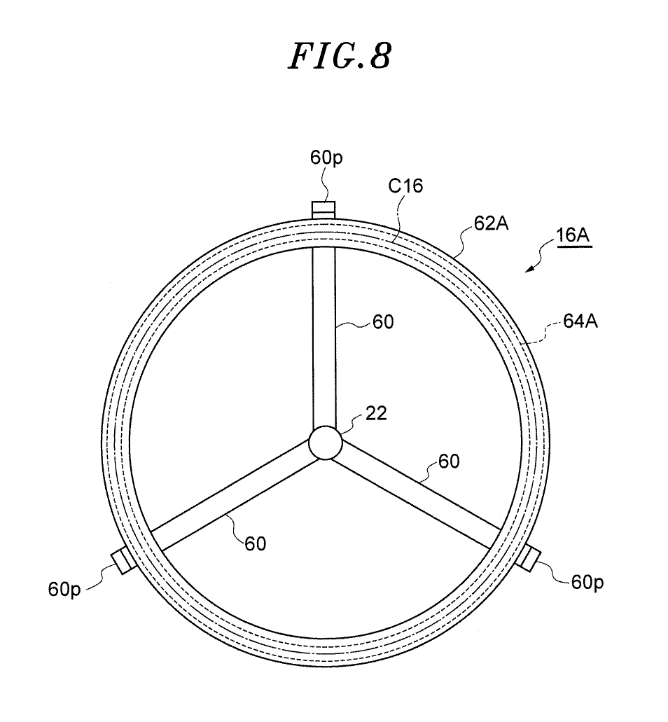

Hereinafter, another embodiment of the present invention will be described. FIG. 8 is a top view showing a holder in accordance with another embodiment of the present invention. In the present embodiment, the heating apparatus 10 may include a holder 16A instead of the holder 16, as shown in FIG. 8. The holder 16A has a contact portion 62A. The contact portion 62A extends in an annular shape along a circle C16 having as its center the axis of rotation of the shaft 22. As in the case of the contact portion 62, the contact portion 62A may have a main portion and a luminous body 64A. In the contact portion 62A, the luminous body 64A may also extend in an annular shape along the circle C16.

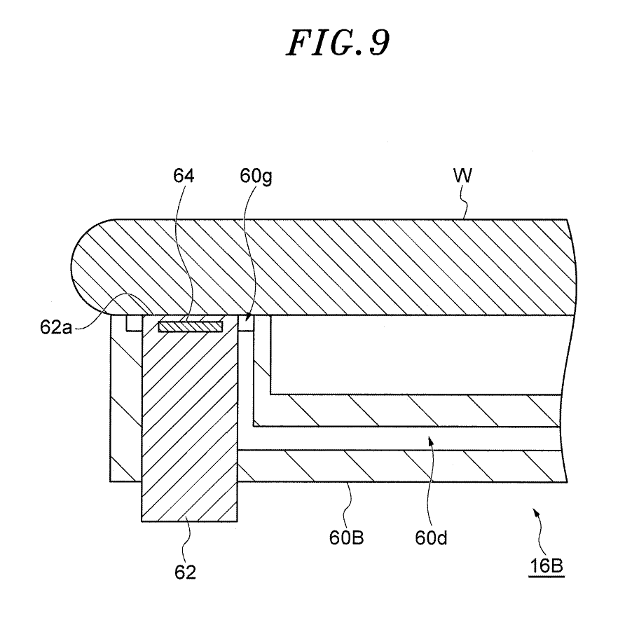

FIG. 9 is an enlarged cross sectional view showing a part of a holder in accordance with a still another embodiment of the present invention. In the present embodiment, a heating apparatus 10 may include a holder 16B instead of the holder 16, as shown in FIG. 9. The holder 16B has substantially the same configuration as that of the holder 16. However, the holder 16B is different from the holder 16 in that each arm 60B has a line 60d and a groove 60g for vacuum-attracting the wafer W. Specifically, the groove 60g is formed at the arm 60B so as to extend along a circumference of a first end 62a of a contact portion 62. The line 60d is formed in the arm 60B to communicate with the groove. A vacuum pump may be connected to the line 60d. In the holder 16B, when the vacuum pump is driven in a state where the wafer W is mounted on the contact portion 62 so as to cover the groove 60g, the groove 60g is vacuum-exhausted through the line 60d and, thus, the wafer W is attracted and held on the holder 16B. The holder 16B enables the wafer W to be firmly held.

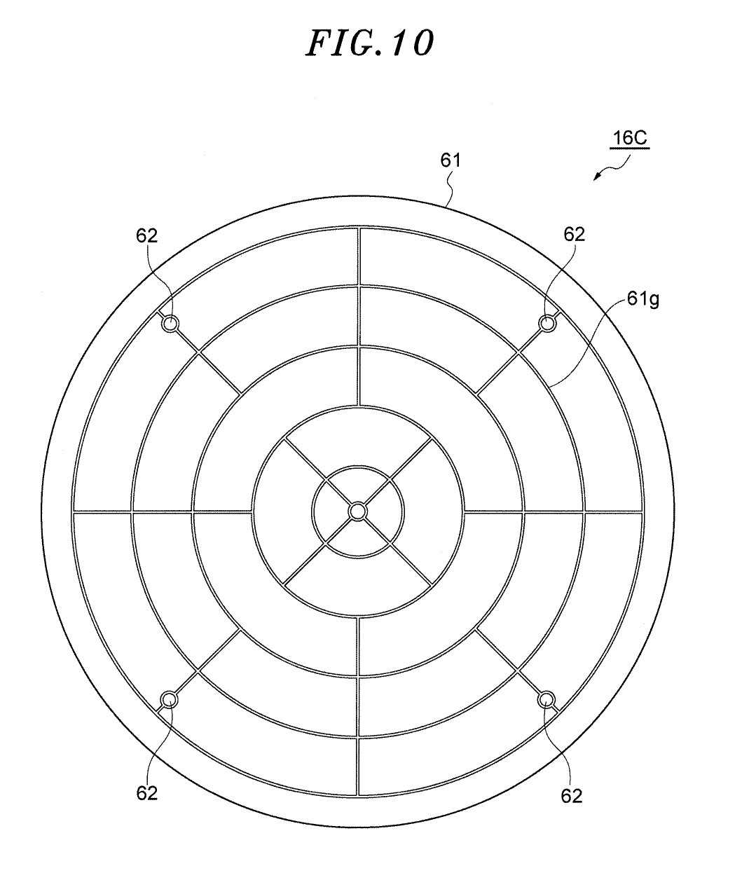

FIG. 10 is a top view showing a holder in accordance with further still another embodiment of the present invention. In the present embodiment, the heating apparatus 10 includes a holder 16C instead of the holder 16 as shown in FIG. 10. The holder 16C has a disc-shaped plate 61. A shaft 22 is coupled to the center of the plate 61. The top surface of the plate 61, i.e., the surface on which the wafer W is mounted, is positioned at the same level as the first end 62a of the contact portion 62. A vacuum suction groove 61g is formed on the top surface of the plate 61. The vacuum suction groove 61g includes a plurality of concentrical grooves and a plurality of grooves extending radially to connect the concentrical grooves. Further, the vacuum suction groove 61g extends along a circumference of the first end 62a of the contact portion 62. Moreover, the vacuum suction groove 61g may be connected to a vacuum pump. Since the holder 16C enables the wafer W to be vacuum-attracted at a wider area, the wafer W can be more firmly held.

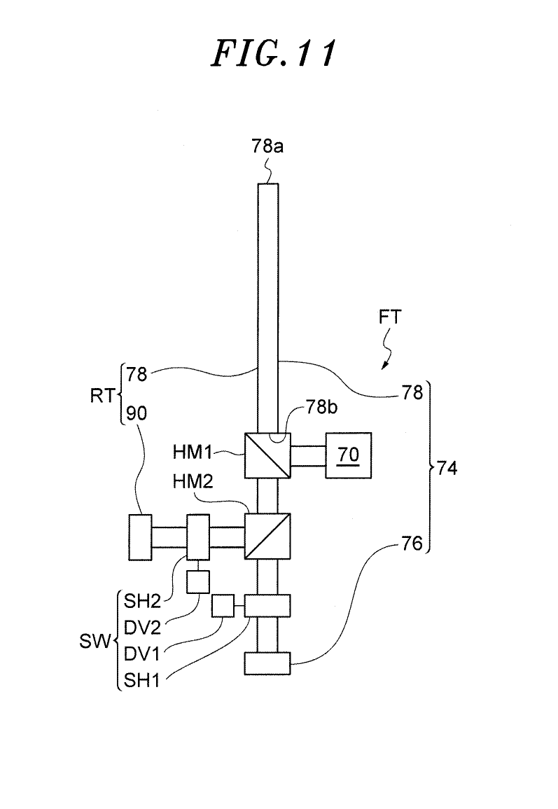

FIG. 11 shows a fluorescent thermometer and a radiation thermometer in accordance with another embodiment of the present invention. In the present embodiment, a light guiding part 78 of at least one light receiver 74 of the fluorescent thermometer FT may also serve as a light guiding part for guiding the light from the light source 70 and a light guiding part of the radiation thermometer RT. Further, the heating apparatus 10 may include a switching unit for selectively operating the fluorescent thermometer FT and the radiation thermometer RT.

Specifically, as shown in FIG. 11, the other end 78b of the light guiding part 78 of at least one light receiver 74 of the fluorescent thermometer FT is optically coupled to the light source 70 through a half mirror HM1 and also optically coupled to the photodetector 76 of the corresponding light receiver 74 through the half mirrors HM1 and HM2. Further, the other end 78b of the light guiding part 78 of the corresponding light receiver 74 is optically coupled to the photodetector 90 of the radiation thermometer RT through the half mirror HM1 and a half mirror HM2.

Furthermore, a shutter SH1 is provided between the half mirror HM2 and the photodetector 76, and a shutter SH2 is provided between the half mirror HM2 and the photodetector 90. A driving unit DV1 is connected to the shutter SH1, and a driving unit DV2 is connected to the shutter SH2. The shutter SH1 is opened and closed by the operation of the driving unit DV1. Further, the shutter SH2 is opened and closed by the operation of the driving unit DV2.

In the embodiment shown in FIG. 11, the fluorescent thermometer FT can operate when the light from the light guiding part 78 is guided to the photodetector 76 by closing the shutter SH2 and opening the shutter SH1. Meanwhile, the radiation thermometer RT can operate when the light from the light guiding part 78 is guided to the photodetector 90 by closing the shutter SH1 and opening the shutter SH2. Hence, in the present embodiment, the shutters SH1 and SH2 and the driving units DV1 and DV2 are used as the switching unit SW. Meanwhile, the driving units DV1 and DV2 can be controlled by control signals from the controller Cnt. In accordance with the present embodiment, the fluorescent thermometer FT and the radiation thermometer RT can share the light guiding part 78 of at least one light receiver 74, so that the arrangement space of the radiation thermometer and the fluorescent thermometer is reduced. In addition, the radiation thermometer and the fluorescent thermometer can measure the temperature of the wafer W at substantially the same area.

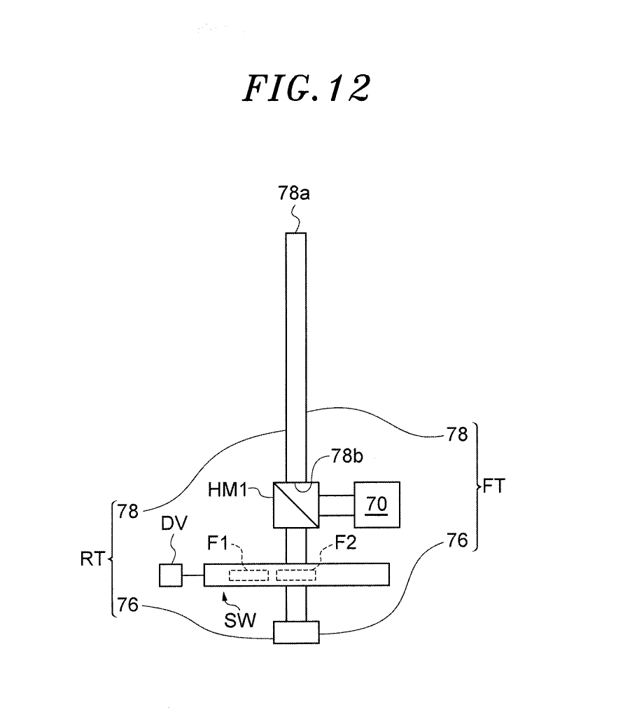

FIG. 12 shows a fluorescent thermometer and a radiation thermometer in accordance with still another embodiment of the present invention. In the present embodiment, the light guiding part 78 of at least one light receiver 74 of the fluorescent thermometer FT may also be used as the light guiding part for guiding the light from the light source 70 and the light guiding part of the radiation thermometer RT. Moreover, the photodetector 76 of the fluorescent thermometer FT may also be used as the photodetector of the radiation thermometer RT.

Specifically, as shown in FIG. 12, the other end 78b of the light guiding part 78 of at least one light receiver 74 of the fluorescent thermometer FT is optically coupled to the light source 70 through the half mirror HM1 and also optically coupled to the photodetector 76 through the half mirror HM1. In the present embodiment, the filter F1 or the filter F2 is selectively provided between the other end 78b of the light guiding part 78 and the photodetector 76, i.e., between the half mirror HM1 and the photodetector 76. For example, the filter F1 and the filter F2 are connected to the driving unit DV and can slide by from the operation of the driving unit DV to selectively move to a position between the photodetector 76 and the other end 78b of the light guiding part 78. Meanwhile, the driving unit DV can be controlled by the control signal from the control unit Cnt.

The filter F1 is an optical filter for selectively passing light of a wavelength range used by the fluorescent thermometer FT, i.e., an optical filter for selectively passing fluorescent light or phosphorescent light from the luminous body 64. The filter F2 is an optical filter for selectively passing a light of a wavelength range used by the radiation thermometer RT, e.g., infrared ray.

In the embodiment shown in FIG. 12, the fluorescent thermometer FT can selectively operate when the filter F1 is disposed between the photodetector 76 and the other end 78b of the light guiding part 78. Further, in the present embodiment, the radiation thermometer RT can selectively operate, the filter F2 is disposed between the photodetector and the other end 78b of the light guiding part 78. Hence, the filter F1, the filter F2 and the driving unit DV are used as the switching unit SW of the present embodiment.

Although various embodiments have been described, the present invention may be modified without being limited to the above embodiments. For example, in the above embodiment, the operation processing unit such as the processing unit 80 of the fluorescent thermometer FT, the temperature calculation unit of the radiation thermometer RT or the like is provided separately from the control unit Cnt. However, the functions of the operation processing unit can be realized by the control unit Cnt.

While the invention has been shown and described with respect to the embodiments, it will be understood by those skilled in the art that various changes and modifications may be made without departing from the scope of the invention as defined in the following claims.

What is claimed is:

1. A heating apparatus comprising:
a heat source configured to heat an object to be processed;
a holder having a contact portion configured to support the object to be processed while being in contact with a surface of the object to be processed;
a rotation driving unit configured to rotate the holder;
a luminous body including a fluorescent material or a phosphorescent material provided in the contact portion; and
a fluorescent thermometer configured to measure a temperature of the object based on light from the luminous body, the fluorescent thermometer including:
a light source which is separated from the holder and configured to generate excitation light for exciting the luminous body;
one or more light receivers separated from the holder, each of the one or more light receivers having a photodetector configured to receive the light from the luminous body; and
a processing unit configured to calculate the temperature based on intensity of the light received by the photodetector of each of the one or more light receivers.

2. The heating apparatus of claim 1, wherein the one or more light receivers include a plurality of light receivers which is arranged along a rotation track of the luminous body to receive the light from the luminous body.

3. The heating apparatus of claim 1, further comprising a radiation thermometer.

4. The heating apparatus of claim 3, wherein each of the one or more light receivers includes a light guiding part having opposite ends, the light being received from the luminous body through one end of the opposite ends when the luminous body is at a predetermined position on a rotation track of the luminous body,
wherein a light guiding part of at least one of the one or more light receivers guides the light from the light source toward the luminous body and also serves as a light guiding part of the radiation thermometer, and
wherein the heating apparatus further comprises a switching unit configured to selectively operate the fluorescent thermometer or the radiation thermometer.

5. The heating apparatus of claim 4, wherein the radiation thermometer includes another photodetector; and
wherein the switching unit has a shutter for selectively and optically coupling the other end of the opposite ends of the light guiding part of said at least one light receiver to the another photodetector of the radiation thermometer or the photodetector of said at least one light receiver.

6. The heating apparatus of claim 4, wherein the radiation thermometer uses the photodetector of said at least one light receiver; and
wherein the switching unit has a first filter allowing a light in a wavelength range used by the fluorescent thermometer to pass therethrough and a second filter allowing a light in a wavelength range used by the radiation thermometer to pass therethrough, the first or the second filter being selectively provided between the other end of the opposite ends of the light guiding part of said at least one light receiver and the photodetector of said at least one light receiver.

7. The heating apparatus of claim 1, wherein the contact portion is made of a material that passes the light from the luminous body therethrough and has a first end that comes into contact with the surface of the object to be processed and a second end opposite to the first end; and
wherein the one or more light receivers are configured to receive the light from the contact portion through the second end of the contact portion.

8. The heating apparatus of claim 1, wherein the heat source supplies a microwave.
